(19) United States
(12) Patent Application Publication
(10) Pub. No.: US 2009/0222998 A1
(43) Pub. Date: Sep. 10, 2009

(54) Combination hammer and nail driver

(76) Inventor: Mark D. Ruggles, Anaheim, CA (US)

Correspondence Address: Karl M. Steins;Steins & Associates, Suite 120, 2333 Camino del Rio South, San Diego, CA, 92108, US

(21) Appl. No.: 12/074,611

(22) Filed: Mar. 5, 2008

(51) Int. Cl. B25D 1/04; B25D 1/00

(52) U.S. Cl. 7/143; 173/90

(57) ABSTRACT

A Combination Hammer and Nail Driver is disclosed. The combination hammer and nail driver provides the benefits of a conventional hammer in addition to the features of a slide hammer (also known as a “pea shooter”). The device resembles a conventional hammer, but be further equipped with an internal bore for housing a slide rod. The hammer has an end cap that retains the slide rod within the internal bore of the hammer. The end of the rod has external threads for engaging the internal threads of a conventional plumb bob. The tip end of the slide rod is magnetized so that a nail will stick to it. Finally, the assembly of the present invention includes a slingshot attachment that can be used to threadedly engage the slide rod to provide another option for driving a nail.

### BACKGROUND OF THE INVENTION

1. Field of the Invention

This invention relates generally to hand tools and, more specifically, to a Combination Hammer and Nail Driver.

2. Description of Related Art

Hammers are one of the oldest hand tools known to man. As such, they have evolved over the years in a number of ways. Two particular advancements are of interest here in the context of the improvements provided by the present invention.

The first hammer advancement discussed here is that of an integrated nail holder. Such a device is depicted in FIG. 1. FIG. 1 is a perspective view of a prior art carpenter's hammer 10. This particular hammer 10 is the subject of U.S. Pat. No. 6,339,974 to Kotschner. et al. The Kotschner device has a conventional handle, but has a head 12 defined by a elongate notch portion 14 running axially along the top surface of the head 12. There is further one or more T-shaped notches 16 at various positions along the axial notch 14. There is further a magnet 18 recessed within the head 12 along the axial notch 14.

In use, the user is able to place a nail in the axial notch 14 with the head of the nail being positioned within one of the T-shaped notches 16 so that the tip of the nail is extending beyond the front face 5 of the head 12. The magnet 18 will hold the nail in place within the notch 14. The user then simply must tap the hammer at the location where he or she desires to drive the nail. What will happen is that the nail will be partially driven into the material at the nailing location. The user then pulls back on the hammer 10, which will release the nail from the magnet 18; the nail will remain protruding from the nailing location. The user then continues driving the nail by striking the head of the nail with the face 5 of the hammer 10. This feature is very convenient because it allows the user to avoid accidentally striking his or her hand while holding the nail and starting to drive it.

A second hammer-related advancement is depicted in FIG. 2. FIG. 2 is a partial cutaway side view of a prior art nail driver 20. The nail driver 20 of FIG. 2 is the subject of U.S. Pat. No. 6,205,602 granted to Dettweiler. The Dettweiler “Multi-purpose Tool” allows the user to drive nails in tight confines, where the user either has problems reaching the nailing location to start the nail or has problems striking the nail head at the nailing location (or swinging the hammer). Devices such as these commonly are called “pea shooters” or “slide hammers.”

The Dettweiler tool 10 has a weighted driver 22, with a rod 24 extending from it. The rod 24 is encased within a sleeve 26 so that it can slide freely. To use the tool 10, the user places a nail 28 within the sleeve 26 (while the rod 24 is somewhat retracted within the sleeve 26). The user would then place the tip of the nail 28 at the nailing location, after which the user strikes the first end 30 of the driver 22. The force of this strike will travel along the driver 22 and the rod 24, and the impact end 32 of the rod 24 will drive the nail 28 into the material at the nailing location.

While each of these prior tools provide individual benefits to the user, they require the user to carry both of them at all times in order to be convenient for use. The user's desire for maximum mobility and minimum carrying weight usually prevents the user from carrying both of them. This means that the tools need to be recovered from their resting place each time they are needed. It is this inconvenience that is solved by the device of the present invention.

### SUMMARY OF THE INVENTION

In light of the aforementioned problems associated with the prior devices, it is an object of the present invention to provide a Combination Hammer and Nail Driver. The combination hammer and nail driver should provide the benefits of a conventional hammer in addition to the features of a slide hammer (also known as a “pea shooter”). The device should resemble a conventional hammer, but be further equipped with an internal bore for housing a slide rod. The hammer should have an end cap that retains the slide rod within the internal bore of the hammer. The end of the rod should bear external threads for engaging the internal threads of a conventional plumb bob. The tip end of the slide rod should be magnetized so that a nail will stick to it. Finally, the assembly of the present invention should also enable a slingshot attachment that can be used to threadedly engage the slide rod to provide another option for driving a nail.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a prior art carpenter's hammer;

FIG. 2 is a partial cutaway side view of a prior art nail driver;

FIG. 3 is a partially exploded side view of a preferred embodiment of the combination hammer and nail driver of the present invention;

FIG. 4 is a cutaway side view of the end cap of the device of FIG. 3;

FIG. 5 is a cutaway side view of the tail end of the handle of the device of FIG. 3;

FIG. 6 is a perspective view of a preferred embodiment of a thread protector element for use with the device of FIGS. 3-5;

FIG. 7 is a perspective view of a preferred embodiment of a plumb bob element for use with the device of FIGS. 3-5;

FIG. 8 is a side view of the device of FIG. 3; and

FIG. 9 is a perspective view of a preferred embodiment of a slingshot attachment for use with the device of FIGS. 3 and 9.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Combination Hammer and Nail Driver.

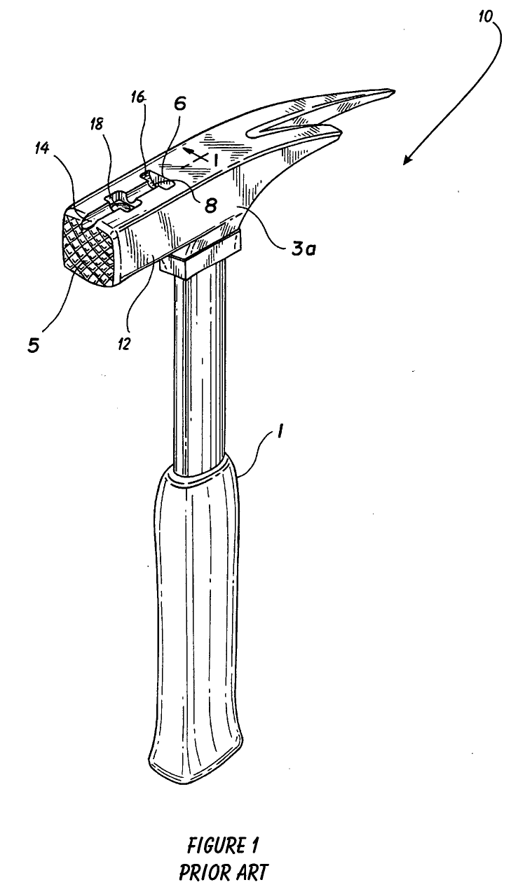

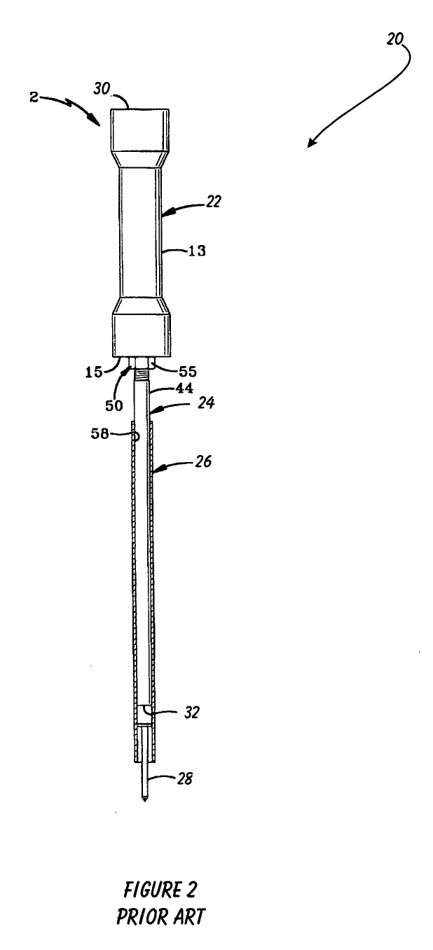

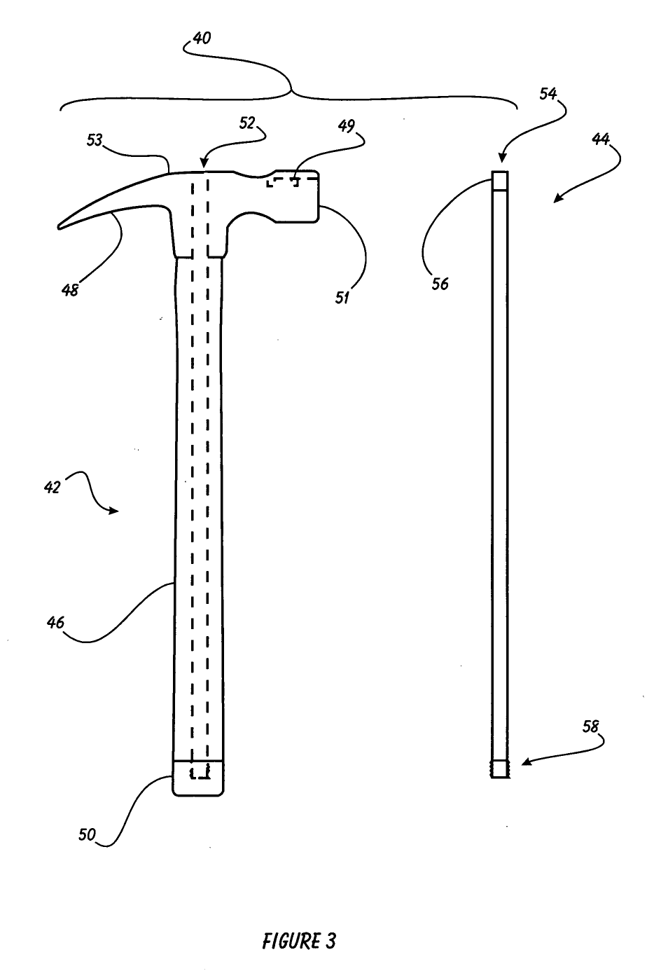

The present invention can best be understood by initial consideration of FIG. 3. FIG. 3 is a partially exploded side view of a preferred embodiment of the combination hammer and nail driver 40 of the present invention. The tool 40 combines the strengths of both a nail-holding hammer such as depicted above in FIG. 1 as well as the slide hammer features such as depicted above in FIG. 2. The tool 40 is made of two main elements—the hammer assembly 42 and the rod 44.

The hammer assembly 42 has a handle 46 and a head 48 attached to its upper end. An end cap 50 is attached to the handle 46 at the opposite (lower) end. There is an internal bore 52 inside of the hammer assembly 42 that is dimensioned to accept the rod 44 therein. In this depicted version, a nail holder 49 is formed in the top surface 53 of the head 48 adjacent to the face 51. The nail holder 49 is substantially the same as the prior art device depicted in FIG. 1, although, while T-shaped slots are located atop the prior hammer at two locations (to accommodate two different sizes of nails), in this device 40, there may be three T-shaped notches in order to accommodate an additional nail size, if desired.

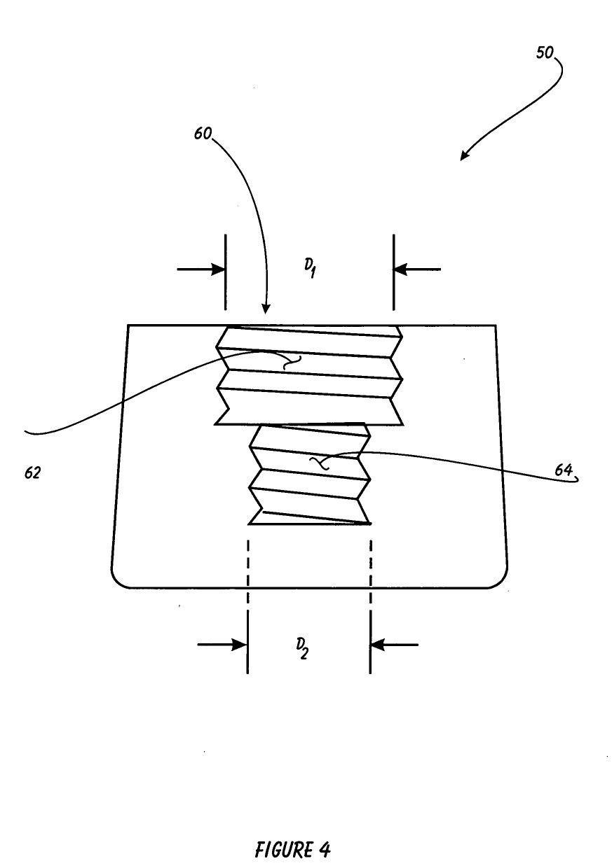

The rod 44 is an elongate rod of durable metal, such as titanium. It defines a tip end 54 and a tail end 58. The tip end 54 will preferably include an integrated magnet 56. The magnet 56 (as will become clear below) is provided to cause nails to stick to the tip 54 while using the slide hammer feature of the device 40. The tail end 58 of the rod 44 has an externally threaded portion; the end cap 50 threadedly engages this portion of the rod 44, as is now discussed in connection with FIG. 4.

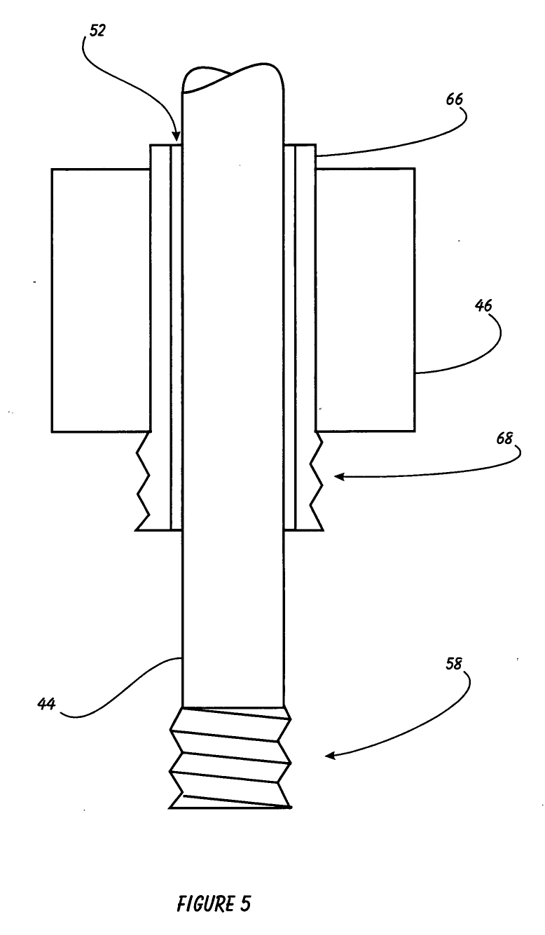

FIG. 4 is a cutaway side view of the end cap 50 of the device of FIG. 3. The end cap 50 has a threaded bore 60 formed within it, but otherwise is preferably made from a solid piece of durable (typically case-hardened) metal that is strong enough to sustain repeated strikes with a hammer. A unique aspect of this bore 60 is that the upper portion 62 of the bore 60 has a wider diameter than the lower portion 64 of the bore 60. The lower portion 64 is defined by a diameter D₂. The threads and diameter D₂ cooperate with the threads and diameter of the tail end of the rod (see FIG. 3) such that the tail end threadedly engages the lower portion 64 of the end cap 50. As should be apparent from the drawing, the diameter D₁ of the upper portion 62 is larger than the diameter D₂ of the lower portion 64. As such, the tail end will pass through (i.e. without threadedly engaging) the upper portion 62. The purpose behind the threaded bore 60 having two diameters is discussed below in connection with FIG. 5.

FIG. 5 is a cutaway side view of the tail end of the handle 46 of the device of FIG. 3. The handle 46 may be made from wood, fiberglass or some other material or combination. The internal bore 52 running the length of the handle 46 is formed within an internal tube 66 located within the handle 46. The internal tube 66 has a threaded tip 68 where it protrudes from the bottom of the handle 46. The tip 68 could also be a feature of the handle 46 itself (and the tube 66 may be eliminated), depending upon material choices.

The outer diameter D₁ of the threaded tip 68 is sized (and threaded) to cooperate with the upper portion of the threaded bore of the end cap (see FIG. 4) for a relative threaded engagement. As discussed previously, the diameter D₂ of the threaded tail end 58 of the rod 44 is sized (and threaded) to cooperate with the lower portion of the threaded bore of the end cap (see FIG. 4).

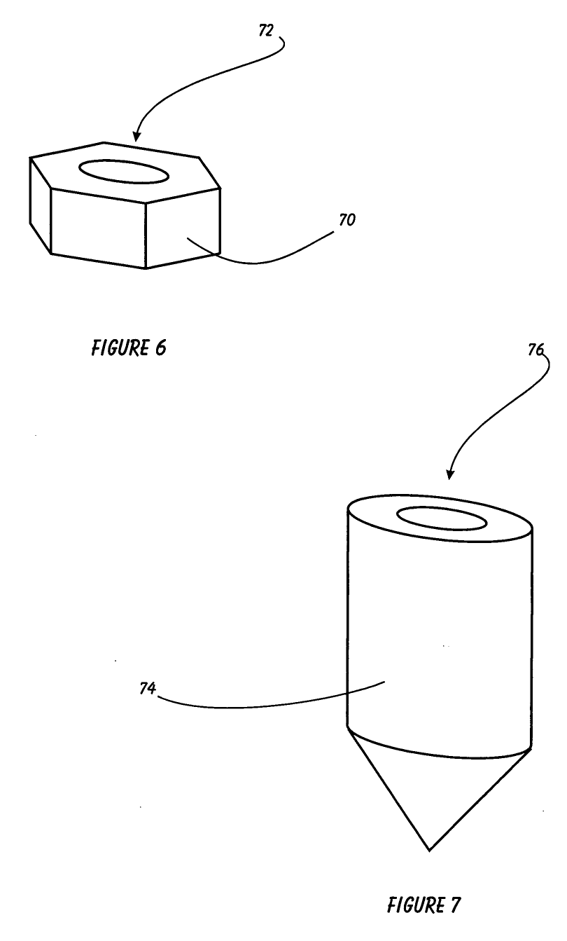

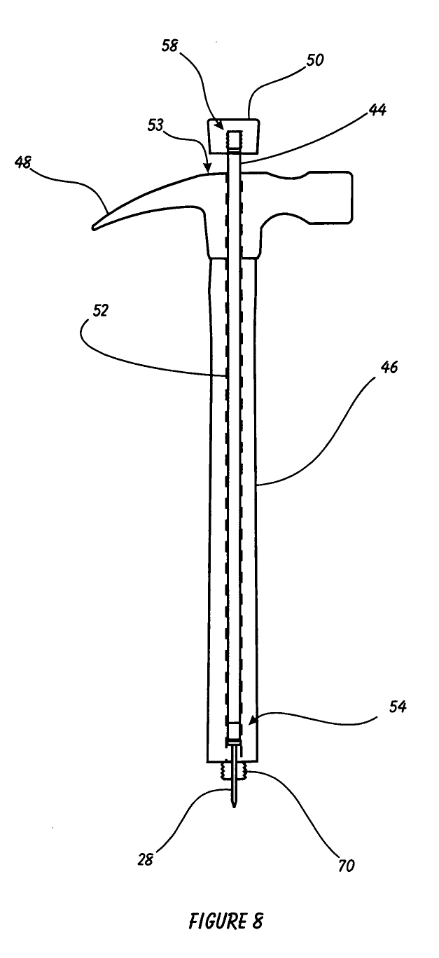

In use, then, the end cap (see FIG. 4) and threaded tail end 58 are threaded together. The internal bore 52 and rod 44 are sized such that the rod 44 is free to slide longitudinally within the bore 52. As a result, rod 44 can be slid upwardly (in this view) until the end cap (see FIG. 4) reaches and threadedly engages the threaded tip 68. When thus arranged, the rod 44 is stored securely within the handle 46. One or more set screws might be provided in the head of the device (see FIG. 3); the set screw(s) could be tightened until they press against the rod 44 inside of the internal bore 52 in order to prevent rattling or vibration from the rod 44 within the bore 52 when hammering with the tool. If we now turn to FIGS. 6 and 7, we can examine additional optional features related to the present invention.

FIG. 6 is a perspective view of a preferred embodiment of a thread protector element 70 for use with the device of FIGS. 3-5. The thread protector element 70 is defined by an inner threaded bore 72 that is dimensioned to threadedly engage the threaded tip (68, see FIG. 5) of the handle 46. While the use of the element 70 is not mandatory, it may be preferred in order to avoid accidental damage to the threads of the threaded tip when the slide hammer feature of the device is being used.

The thread protector element 70 would not normally be attached to the threaded tip [because the end cap (50, see FIG. 4) will be attached to the threaded tip]. The user would tighten the threaded protector element 70 to the threaded tip right before using the slide hammer feature; when done, the element 70 can be removed and placed in a tool belt (on the user's person) and the end cap 50 can be re-attached to the threaded tip (68).

FIG. 7 is a perspective view of a preferred embodiment of a plumb bob element 74 for use with the device of FIGS. 3-5. This is essentially a conventional plumb bob having a generally cylindrical body tapering to a pointed tip at one end. There is a threaded bore 76 formed within the body of the plumb bob 74. Unlike the thread protector element of FIG. 6, the threaded bore in this element 74 is configured to engage the threaded tail end (58, see FIG. 5) of the rod. The plumb bob 74 would be attached to the rod end in place of the end cap in order to add an additional 16 to 24 ounce driving force to the slide hammer. The operation of the device as a slide hammer is illustrated in FIG. 8.

FIG. 8 is a side view of the device 40 of FIG. 3. Here, the end cap 50 has been released from the threaded tip (68, see FIG. 5), and any set screw 67 is loosened, so that the rod 44 can be slid up and down along the internal tube 66 (the bore within, that is). Either the end cap 50 is removed from the rod 44, or the rod 44 is slid completely out of the internal tube 66 so that the thread protector element 70 can be installed over the threads of the threaded tip (68, see FIG. 5).

After the threaded bore 76 of the plumb bob element 74 is threadedly engaged to the threaded tail end 58 of the rod 44, the rod 44 is inserted tip-first into the internal bore 52 through the top face 53 of the head 48. A nail 28 (magnetically attached to the tip 54 of the rod 44) is then driven into the selected spot by hand-sliding the rod 44 down to the desired nailing location.

As can be seen, a void has been created at the head end of the internal tube 66. The user can magnetically attach the head of a nail 28 to the tip 54 of the rod 44; the internal tube 66 is sized so that it will stabilize the nail 28. Now, the user simply places the tip of the nail 28 at the (remote) nailing location, and strikes the bottom face 69 of the end cap until the nail 28 is fully nailed in.

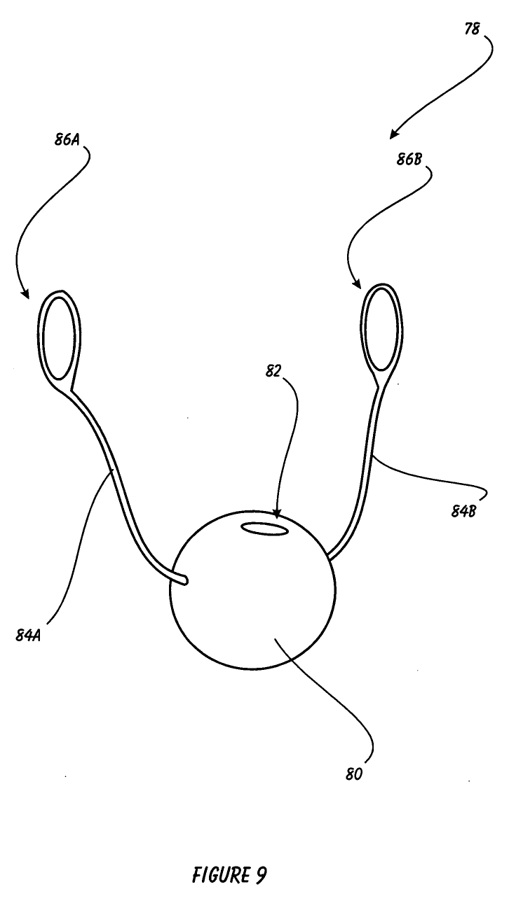

Alternatively, the user could remove the rod 44 from the internal tube 66 and reverse it end-for-end. In that orientation, the end cap 50 would be located at the head end of the device 40, and the nail 28 would be poking out through the internal tube 66 at the end having the thread protector element 70 installed. This would provide a smaller profile, which might enable the user to drive nails into tighter spaces that do not have sufficient clearance to accept the entire head 48 therewithin. Either orientation is expected to provide users with a valuable tool for driving nails into remote locations. Finally, turning to FIG. 9, we can examine a final accessory for the device of the present invention.

FIG. 9 is a perspective view of a preferred embodiment of a slingshot attachment 78 for use with the device of FIGS. 3 and 9. The slingshot element 78 allows the slide hammer feature of the device to be used without the need for a second hammer. The element 78 has a pull weight 80 that is shaped to be easily grasped by hand. The weight 80 has a threaded bore 82 formed within it for threaded engagement with the rod (44, see FIG. 8). There is a pair of elastic band 84A and 84B extending from the pull weight 80. Elastic band 84A ends in a first loop 86A; elastic band 84B ends in a second loop 86B. One of the loops (86A, 86B) is stretched over the one end of the hammer head and the other loop is stretched over the other end of the hammer head. As can be imagined, if the rod 44 is inserted into the internal tube 66 as depicted in FIG. 5 with the loops 86A, 86B stretched over the head 48 of the hammer assembly, the elastic band 84A, 84B will be stretched out such that it is exerting force against the pull weight 80. The user can then insert a nail 28, just as shown in FIG. 5 and pull back on the pull weight 80 (further stretching out the elastic bands 84A, 84B). When the user releases the pull weight 80, the rod 44 will be forced to slide down the internal tube 66 until the nail 28 is driven into place. If desired, the user can then continue to drive the nail 28 by repeatedly pulling back and releasing the pull weight 80 until the nail 28 is fully driven.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A hammer, comprising:
an elongate handle defining a first end and a second end and an central bore formed in said handle interconnecting said first and second ends;
a hammering head attached to said first end;
a slide rod slidingly engaging said handle within said internal bore; and
an end cap attached to said slide rod and attachable to said second end of said handle.

2. The hammer of claim 1, wherein said handle further comprises an internal tube forming said central bore.

3. The hammer of claim 2, wherein said internal tube is defined by a first end at said handle first end and a second end at said handle second end, said internal tube protruding from said second end of said second end of said handle, said second end of said internal tube defined by external threads.

4. The hammer of claim 3, wherein said slide rod defines by a tip end and a tail end, said tail end having external threads formed adjacent thereto.

5. The hammer of claim 4, wherein:
said external thread portion of said internal tube defines a first diameter;
said external thread portion of said tail end defines a second diameter; and
wherein said second diameter is less than said first diameter.

6. The hammer of claim 5, wherein said tip end of said slide rod is defined by a magnetized element.

7. The hammer of claim 6, wherein said end cap is defined by an internal threaded bore, said internal threaded bore is defined by an upper portion and a lower portion, said upper and lower portions defining relative different diameters.

8. The hammer of claim 7, wherein said upper portion of said end cap internal threaded bore is accessed through an aperture formed in said end cap and said lower portion of said end cap internal threaded bore is adjacent to said upper portion opposite to said aperture.

9. The hammer of claim 8, wherein said lower portion defines a diameter cooperating with said slide rod element whereby said lower portion and said slide rod external thread portion are threadedly engageable.

10. The hammer of claim 9, wherein said upper portion defines a diameter cooperating with said internal tube threaded portion whereby said internal tube threaded portion and said upper portion of said end cap are threadedly engageable.

11. The hammer of claim 10, further comprising a thread protector element defined by a body and a threaded bore formed therethrough, said threaded bore defining a diameter substantially the same as said end cap upper portion.

12. The hammer of claim 11, further comprising one or more nail holders formed atop a top surface of said hammering head, each said nail holder comprising a T-shaped notch formed in said top surface.

13. A combination hammer and slide hammer, comprising:
a hammer assembly defined by an elongate handle defining a first end and a second end and an central bore formed in said handle interconnecting said first and second ends and a hammering head attached to said first end and an end cap attached to said second end; and
a slide rod slidingly engaging said handle within said internal bore.

14. The combination of claim 13, wherein said slide rod defines by a tip end and a tail end, said tail end having external threads formed adjacent thereto.

15. The combination of claim 14, wherein said tip end of said slide rod is defined by a magnetized element.

16. The combination of claim 15, wherein said handle further comprises an internal tube forming said central bore, said internal tube is defined by a first end at said handle first end and a second end at said handle second end, said internal tube protruding from said second end of said second end of said handle, said second end of said internal tube defined by external threads defining a first diameter.

17. The combination of claim 16, wherein:
said external thread portion of said tail end defines a second diameter; and
wherein said second diameter is less than said first diameter.

18. The combination of claim 17, wherein said end cap is defined by an internal threaded bore, said internal threaded bore is defined by an upper portion and a lower portion, said upper defining a diameter that cooperates with said first diameter and said lower portion defining a diameter that cooperates with said second diameter.
